(19) United States
(12) Patent Application Publication
(10) Pub. No.: US 2015/0235208 A1
(43) Pub. Date: Aug. 20, 2015

(54) PROOF-OF-VERIFICATION NETWORK

(71) Applicant: Bank of America Corporation, Charlotte, NC (US)

(72) Inventors: Matthew D. Murphy, Charlotte, NC (US); Jeffrey N. Healy, Matthews, NC (US); Steven M. Twombly, Saco, ME (US); Rosemary C. Stack, Wilmington, DE (US); Mark R. Wilson, Middletown, DE (US)

(73) Assignee: Bank of America Corporation, Charlotte, NC (US)

(21) Appl. No.: 14/184,532

(22) Filed: Feb. 19, 2014

(51) Int. Cl. G06Q 20/38; G06Q 20/24; G06Q 20/02

(52) U.S. Cl. CPC G06Q 20/382; G06Q 20/02; G06Q 20/24

(57) ABSTRACT

Apparatus and methods for allocating transaction liability are provided. A first transaction participant may be may be immunized from undesirable effects of fraud/chargebacks associated with a transaction if information responsive to a level of verification is submitted directly to a second transaction participant. The transaction may be an on-us transaction or may be associated with any issuer. The second transaction participant may include a payment guarantee provider. The information may be routed to the second transaction participant via a proof-of-verification network. Transactions that are associated with a level of verification may be subject to variable interchange rates. The interchange rates or level of immunization from fraud/chargeback may vary with respect to the level of verification performed by the first transaction participant.

### FIELD OF TECHNOLOGY

Aspects of the disclosure relate to providing apparatus and methods for mitigating a risk of incurring a liability for a transaction between two or more transaction participants.

### BACKGROUND

A customer may purchase goods or services (“the product”) from a merchant by presenting a payment instrument at a point-of-sale. The purchase may be conducted through any suitable channel of commerce. The payment instrument may allow the customer to draw on a line-of-credit. The line-of-credit may be extended to the customer by an issuing bank (the “issuer”) associated with the payment instrument. The payment instrument may allow the customer to submit a request to debit of an account of the customer held at a financial institution. The account of the customer may be maintained by the issuer associated with the payment instrument.

The merchant may present the transaction to an acquiring bank (the “acquirer”). The acquirer may request authorization for the transaction from the issuer. The issuer may be provided an opportunity to authorize the transaction before extending credit to the customer or before accepting the request to debit the account of the customer. Typically, by providing authorization for the transaction, the issuer accepts a post-authorization risk associated with the transaction. The post-authorization risk may include allegations of fraud or chargebacks that arise after the authorization has been provided. An issuer may decline to accept the post-authorization risk by denying the transaction in response to the authorization request.

The acquirer may request authorization from the issuer by submitting the transaction to a transaction processing network. The transaction processing network may link the acquirer, the issuer and other transaction participants. The transaction processing network may receive an authorization from the issuer and transmit the authorization to the acquirer. In response to receiving the authorization from the issuer, the merchant may release the product to the customer.

In response to receiving an authorization from the issuer (i.e., via the transaction processing network), the acquirer pays the merchant for (and thus “acquires”) the transaction. The transaction processing network may collect transaction processing network fees from the issuer and the acquirer in connection with a transaction settlement process. The transaction processing network in communication with the issuer and the acquirer may settle the transaction between the issuer and the acquirer.

Settling the transaction may include the transaction network receiving a plurality of transactions from the acquirer. Each transaction may be embodied in a transaction record. A transaction record may include one or more attributes of the transaction. For example, each of the plurality of transaction records may comprise a purchase price amount authorized by the issuer.

A transaction settlement process may include a transfer of funds between two or more transaction participants. The transfer may be a “book transfer,” an inter-bank transfer or any suitable transfer between the transaction participants. A settlement network may transfer the funds between transaction participants. Illustrative settlement networks may include the Federal Reserve Wire Network (“Fedwire”) and other suitable settlement networks that are well known to those of ordinary skill in the art. The settlement network may include any suitable network linking one or more accounts of transaction participants.

A transaction participant may impose a transaction cost upon another transaction participant for participating in the transaction. The transaction cost may be referred to as “interchange.” Interchange may be a fixed fee for the transaction or a percentage of the transaction. Interchange may be a combination of a fixed fee and a percentage of the transaction.

Interchange typically flows from the acquirer, through the transaction processing network, to the issuer. For example, the issuer may transfer to the acquirer an amount net interchange. The issuer typically levies interchange to cover costs of acquiring credit/debit customers, servicing credit/debit accounts, providing incentives to retain customers, mitigating fraud, covering customer credit risk, group compensation, producing payment instruments and other expenses.

The acquirer may deduct a merchant discount from the amount that the acquirer pays the merchant in exchange for the product. The merchant discount may cover the acquirer's transaction processing network fee, interchange, and other expenses. The merchant discount may include a profit for the acquirer.

FIG. 1 shows typical transaction settlement flow 100. Flow 100 involves transaction participants such as the merchant, the customer, and transaction participants identified below. At step 1, the merchant provides $100 in product to the customer. To obtain the $100 in product, the customer may present a payment instrument. Presenting the payment instrument to the merchant may initiate a credit, debit or other electronic transaction. Presenting the payment instrument to the merchant may transfer information associated with the payment instrument to the merchant.

At step 2, the merchant submits a request for authorization to a transaction authorization and clearance provider. The transaction authorization and clearance provider may be an issuer associated with the payment instrument presented by the customer. The authorization request may be communicated to the transaction authorization and clearance provider by the acquirer.

The transaction authorization and clearance provider may provide transaction authorization and clearance information to the merchant/acquirer. The transaction authorization information may be transferred from the issuer to the merchant via a transaction processing network. The transaction authorization and clearance information may include authorization for the transaction to proceed.

At step 3, the issuer transmits to the customer a statement showing the purchase price of $100.00 due. The issuer collects the purchase price amount, along with interest and fees if appropriate, from the customer. At step 4, the issuer routes the purchase price amount of $100.00 through the transaction processing network to the acquirer. At step 5, the acquirer partially reimburses the merchant for the purchase price amount. In the example shown in FIG. 1, the partial reimbursement is $98.00. The difference between the reimbursement amount $98.00 and the purchase price amount $100.00 is a two dollar $2.00 merchant discount.

At step 6, the acquirer pays a transaction cost $1.50, via the transaction processing network, to the issuer. At step 7, both the acquirer and the issuer pay a transaction cost ($0.07 for acquirer and $0.05 for the issuer) to the transaction processing network.

TABLE 1
Net positions, by participant, based on settlement
flow 100 (shown in FIG. 1).

| Participant | Net ($) |
|---|---|
| Issuer | 1.45 |
| Acquirer | 0.43 |
| Transaction | 0.12 |
| processing network | |
| Merchant | −2.00 |
| Customer | 0 |

In settlement flow 100 (shown in FIG. 1), the transaction cost is based on an exemplary merchant discount rate of 2%. The $1.50 interchange is based on an exemplary interchange rate of 1.5%. The sum of the transaction processing network fees ($0.07 and $0.05) is based on a total exemplary transaction processing network fee rate of 0.12%.

Transaction processing networks and transaction processing network services are offered under trademarks known to those of ordinary skill in the art. Transaction processing networks and transaction processing network services offered under trademarks known to those of ordinary skill in the art such as VISA, MASTERCARD, NYCE and PULSE. Transaction processing networks may set interchange rates. Issuers may set interchange rates. Interchange rates may vary for each transaction processing network. Interchange rates may vary based on merchant type and size, transaction processing method, transaction volume and other factors.

In a typical settlement flow, such as FIG. 1, after step 2, when the issuer provides authorization for the transaction, the issuer bears responsibility for any charges or allegations of transaction fraud that may arise after authorization has been provided. For example, the customer may allege that, at step 1 the payment instrument information was fraudulently provided to the merchant. As a result of the allegation, the customer may refuse to pay one or more of the settlement, interest or fees depicted in step 3 of FIG. 1. Typically, the issuer bears a responsibility of investigating such an allegation of fraud. A cost of investigating an allegation of transaction fraud may be $15-$20 per transaction.

The costs associated with transaction fraud may include evaluating merits of a claim of transaction fraud, identifying a source of a fraud, reimbursing the customer, waiving one or more fees charged to the customer or other suitable costs. At least a portion of the interchange may be utilized by the issuer to cover the cost of transaction fraud.

Interchange rates may be regulated. For example, a governmental agency such as the U.S. Treasury Department may issue regulations setting a maximum amount for an interchange fee. Interchange rates may be regulated for credit, debit or other electronic transactions. Regulation of interchange may limit a portion of interchange available for responding to transaction fraud.

It would be desirable, therefore, to provide apparatus and methods for mitigating a risk that a transaction may incur a post-authorization charge.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a prior art scenario;

FIG. 2 shows an illustrative apparatus in accordance with the principles of the invention;

FIG. 3 shows an illustrative apparatus in accordance with the principles of the invention;

FIG. 4 shows an illustrative arrangement of apparatus in accordance with the principles of the invention;

FIG. 5 shows an illustrative arrangement of apparatus in accordance with the principles of the invention;

FIG. 6 shows an illustrative arrangement in accordance with the principles of the invention;

FIG. 7 shows an illustrative arrangement in accordance with the principles of the invention;

FIG. 8 shows an illustrative arrangement in accordance with the principles of the invention;

FIG. 9 shows an illustrative arrangement in accordance with the principles of the invention;

FIGS. 10A and 10B show an illustrative process in accordance with the principles of the invention;

FIGS. 11A and 11B show an illustrative process in accordance with the principles of the invention;

FIG. 12 shows an illustrative process in accordance with the principles of the invention; and

FIG. 13 shows illustrative information in accordance with the principles of the invention.

### DETAILED DESCRIPTION OF THE INVENTION

Apparatus and methods for a proof-of-verification network are provided. The transaction may be initiated by a customer presenting a payment instrument to make a purchase. The payment instrument may be a credit card, debit card, prepaid card, stored value card, gift card, ATM card, affinity-branded card, check card, corporate card, rewards card, charge card, embossed card, smart card and/or or any suitable payment instrument.

A payment instrument may store information in a magnetic strip, a bar code, a silicon chip, non-volatile computer readable media or any other suitable data storage device or format. A payment instrument may include an instrument or device that includes a transponder, radio frequency instrument, contactless chip, such as an ISO14443-compliant contactless chip, a smart phone, a tablet computer, or any other suitable device for communicating payment instrument information. Illustrative payment instrument informational items are shown below in table 2.

TABLE 2
Illustrative Payment Instrument Informational Items

Issuer
Transaction network
Customer name
Expiration date
Card security code (“CSC”)
Card verification data (“CVD”)
Card verification value (“CVV,” “CVV2,” “iCVV” or “Dynamic CVV”)
Card verification value code (“CVVC”)
Card verification code (“CVC” or “CVC2”)
Verification code (“V-code”)
Card code verification (“CCV”)
Signature panel code (“SPC”)
Customer identification number (“CID”)
Card account number
Brand
Card present transaction
Card not present transaction
Data storage (i.e., magnetic strip, smartphone, smart card ect . . . )
Affinity

A payment instrument may be presented to a merchant by the customer as payment for the product. The merchant may provide a point-of-sale (“POS”) terminal that is configured to receive data from, provide data to, or exchange data with the payment instrument. Presenting the payment instrument may initiate a transaction.

The transaction may be a transaction in any state of completion. The transaction may be a prospective transaction. The prospective transaction may include the merchant collecting payment instrument information from the customer. Illustrative payment instrument informational items that may be communicated to a POS terminal are shown above in table 2.

The transaction may be a pending transaction. For example, a transaction may be pending prior to receiving authorization from the issuer. The transaction may be pending during a time between receiving the authorization and settlement. The transaction may be pending during a time prior to collection, by the issuer, of the purchase amount from the customer.

The transaction may be an executed transaction. Executing a transaction may include a first transaction participant transferring the transaction or a transaction record to a second transaction participant. An executed transaction may include a transaction that has been authorized and settled.

More than one transaction participant may be available to participate in the transaction. Table 3 shows illustrative transaction participants.

TABLE 3
Illustrative Transaction Participants

Merchant
Customer
Authorization service provider
Clearance service provider
Settlement service provider
Issuer
Transaction processing network
Acquirer
Payment guarantee provider

Different transaction participants of the same type may have advantages and/or disadvantages relative to the other participants of that type. For example, one issuer may be a member of a lending consortium while another issuer is not a member, one transaction processing network may require payment of a relatively small interchange fee while another network may require payment of a relatively large interchange fee, and the like.

The transaction may be associated with one or more transaction attributes. A transaction record may be generated based on transaction attributes received and/or available at a time of the transaction is initiated. Each transaction record may include one or more fields. Each field may include an attribute of the transaction. A transaction record may include one or more fields storing information associated with an attribute. Table 4 shows illustrative transaction attributes and illustrative information associated with the attribute.

TABLE 4

| Illustrative Transaction | Illustrative Associated |
|---|---|
| Attributes | Information |
| Geographic | Longitude/latitude |
| | GPS coordinates |
| | Map coordinates |
| | Elevation |
| | Depth |
| | Distance from a point |
| | Address |
| | Zip code |
| | Area code |
| | County |
| | State |
| | Country |
| | IP address |
| | Signal triangulation |
| Temporal | Seconds |
| | Minutes |
| | Hours |
| | Day |
| | Week |
| | Month |
| | Year |
| | Duration |
| Synoptic | Weather at time of |
| | transaction |
| | Stock market performance at |
| | time of transaction |
| | Political party in power at |
| | time of transaction |
| | Transaction participant risk |
| Transaction | Dollars |
| | Available credit |
| | Currency |
| | Foreign exchange rate |
| | Card present |
| | Card not present |
| Number of items purchased | Number |
| | Number of distinct stock |
| | keeping units (“SKU”) |
| | Cost/Value of item |
| Merchant category code | Numerical identifier |
| | Taxation status |
| | Associated acquirer |
| Payment instrument | Type (i.e., credit, debit, |
| | rewards ect . . . ) |
| | Data storage (i.e., magnetic |
| | strip, smartphone, smart card |
| | ect . . . ) |
| | Brand |
| | Transaction Network |
| | Issuer |
| | Acquirer |
| | Affinity |
| Loyalty program | Rewards/point balance |
| | Membership level |
| | Duration of membership |
| | Frequency of use |
| Access Channel | Point-of-sale |
| | Automated teller machine |
| | Online portal |
| | Self-service kiosk |
| | Mobile device |
| | In person |

A transaction attribute may be a synoptic attribute. The synoptic attribute may be derived by grouping individual transaction records that share one or more attributes. For example, transaction records may be grouped based on a common surcharge. Transaction records may be grouped based on date, merchant category code (“MCC”), number of items purchased or a credit card identifier.

A transaction risk may be allocated among one or more transaction participants. A transaction risk may include a possibility of incurring a liability associated with the transaction. The liability may include costs associated with the transaction that are incurred after an issuer has authorized the transaction. For example, a transaction liability may include cost associated with transaction fraud. Exemplary costs associated with transaction fraud are listed below in Table 5.

TABLE 5
Illustrative Costs of Transaction Fraud

Investigation allegations of fraud
Damage to corporate goodwill
Monetary compensation paid to settle fraud
claims
Delay in receiving payments due
Payments to Acquirer/Merchant
Payments to Transaction Processing Network
Invoicing costs for transaction services

A transaction liability may include other suitable costs. For example, a post-authorization cost may include chargeback costs.

A chargeback provides an issuer with a method of returning a transaction disputed by a customer. A chargeback situation may arise for reasons that include: a merchant failed to obtain an authorization, a transaction record that is altered, a transaction record that does not include a signature of the customer or a valid personal-identification-number (“PIN”), a merchant failed to obtain an imprint (electronic or manual) of a payment instrument presented by the customer and/or a merchant accepted an expired payment instrument.

When a chargeback right applies, the issuer sends the transaction back to the acquirer and “charges back” the dollar amount of the disputed purchase. The acquirer may then deduct the amount of the chargeback from the merchant's account. If there are no funds in the merchant's account to cover the chargeback amount, the acquirer may be obligated to cover a loss associated with the chargeback.

A merchant may re-present the chargeback to its acquirer. If the merchant cannot remedy the chargeback (i.e., by showing that an imprint of the payment instrument has been obtained), the merchant bears a loss associated with the chargeback.

### Proof-of-Verification Network

Apparatus may include and methods may involve a point-of-sale (“POS”) system. The POS system may dynamically select an authorization method for a transaction initiated by a customer. The transaction may be a debit transaction or any suitable transaction initiated by presenting a payment instrument to a merchant.

The system may include a non-transitory computer readable medium having computer readable program code (“code”) embodied therein. The system may include a processor. The processor may execute the code.

The code when executed by the processor may determine an attribute of the transaction. The attribute may be included in a transaction record. The code may determine the attribute by parsing the transaction record. For example, the code may identify an issuer associated with the payment instrument and/or an acquirer bank of the merchant.

A issuer and an acquirer may be operated by a single entity. For example, a financial institution may operate a first line-of-business that provides issuer transaction services. The financial institution may operate a second line-of-business that provides acquirer transaction services. When the issuer and the acquirer are operated by a single entity, a transaction may be an “on-us” transaction. When the issuer and the acquirer are not operated by a single entity, a transaction may be an “off-us” transaction.

For an off-us transaction, the transaction may be submitted to a transaction processing network for authorization. The transaction may be associated with a first liability schedule. The first liability schedule may assign liability for a post-authorization charge associated with the transaction to one or more transaction participants.

For example, the first liability schedule may assign liability for a post-authorization charge to the merchant. The first liability schedule may be imposed by a transaction participant. For example, the transaction participant may be imposed by an issuer on the merchant. According terms of the first liability schedule, a merchant may agree to bear at least a portion of the post-authorization risk.

The first liability schedule may include a default allocation of liability for the transaction. The default allocation may include sharing any post-authorization costs among two or more transaction participants.

For an on-us transaction, the code may determine a level of authorization for the transaction. The level of authorization may be determined based on a performance metric. The performance metric may be determined based on attributes of one or more transactions. The performance metric may be determined based on one or more transactions associated with a transaction participant. For example, the performance metric may be determined based on transactions corresponding to purchases from a merchant. The performance metric may be any suitable performance metric. Table 6 lists illustrative performance metrics.

TABLE 6
Illustrative Performance Metrics

Transaction volume (number)
Transaction volume ($)
Transaction frequency (per item)
Transaction frequency (per sale)
Total sales
Sales per fiscal period
Number of credit card purchases
Number of non-credit card purchases
Number of items purchased
Cost/price per item purchased
Same store sales
Number of transactions authorized per
instrument product type
Number of transaction denied
Interchange revenue per transaction
Interchange revenue per merchant
Interchange revenue per payment instrument
Daily interchange revenue
Number of chargebacks
Number of customer inquiries regarding
transaction participant behavior
Number of fraud investigations associated
with transaction attribute(s)
Number of customer complaints regarding
transaction participant behavior

The level of authorization may be associated with a second liability schedule. The code may transmit to a transaction participant a first option to submit information responsive to the level of authorization according to a second liability schedule. The second liability schedule may be imposed on the merchant by the issuer. The code may provide for selection of the first option.

According to terms of the second liability schedule, an issuer may agree to bear, at least a portion of, a risk that the transaction may incur a post-authorization charge. The post-authorization charge may include a fraud allegation fee or a chargeback fee associated with a transaction. The code may submit the debit transaction for authorization in accordance with the merchant selection.

Illustrative information that may be requested by a level of authorization is shown below in table 7. The information may be requested by a transaction participant to reduce a risk of authorizing a transaction that may incur a post-authorization charge. Any suitable combination of the information in table 7 may be requested.

TABLE 7
Illustrative Informational Items Requested By A
Transaction Participant

Use designated transaction processing network
Require PIN entry
Display photo ID
Scan barcode on photo ID
Swipe a second payment instrument (for verification purposes only)
Enter billing zip code
Enter billing phone number
Enter billing address street number
Enter birthdate
Enter expiration date associated with payment instrument
Enter portion of card number (i.e., last four digits, entire number)
Respond to text message from transaction participant
Require merchant to transmit transaction “batch” within 24 hours of
authorization

A level of authorization may include code that, when executed by the processor, requires a customer to enter, at the POS, a personal-identification-number associated with the payment instrument. The level of authorization may prevent the customer from signing at the POS to authorize the debit transaction.

The level of authorization may include code that, when executed by the processor, requires a customer to enter, at the POS, a zip code associated with the payment instrument and requires the customer to sign to authorize the debit transaction.

The level of authorization may include code that, when executed by the processor, requires transmitting, from the POS, a characteristic displayed on the payment instrument. In response to receiving the characteristic, the code may determine whether the characteristic is associated with the debit transaction. The code may determine whether the characteristic is associated with the debit transaction before authorizing the transaction and/or after authorizing the transaction.

Illustrative characteristics are shown above in table 2. The characteristic may be any suitable portions of the information items listed in table 2. For example, the characteristic may include the last four digits of the card number displayed on the payment instrument.

A level of authorization may include code that, when executed by a processor requires, capturing, at the POS, a barcode displayed on a photo identification of the customer. After capturing the barcode, the code may transmit the barcode from the POS to the issuer.

The level of authorization may include code that, when executed by the processor requires transmitting, from the POS to the issuer, confirmation that a name displayed on a photo identification of the customer corresponds to a name displayed on the payment instrument. The merchant may accept responsibility for verifying the correspondence.

In response to receiving information required by a selected level of authorization, a transaction may be authorized. In some embodiments, the code may submit an authorization request to a transaction processing network. In some embodiments, after receiving information responsive to a level of authorization, no further authorization may be required.

In response to receiving information required by the level of authorization, a transaction may be associated with a payment guarantee. The second liability schedule may include the payment guarantee.

Typically, an issuer may guarantee that, after the issuer provides authorization for the transaction, a post-authorization charge will not reduce or otherwise impact an amount of funds transferred from the issuer to the merchant, acquirer and/or other transaction participant. However, the issuer may be unwilling to provide a payment guarantee without mitigating a risk that the post-authorization charge may be incurred. A payment guarantee may be provided by any suitable transaction participant to another transaction participant.

The code may transmit, to a transaction participant for selection, a second option to submit a transaction to a transaction processing network for authorization according to the first liability schedule. The first liability schedule may be imposed on the merchant by the issuer. The first liability schedule may not include a payment guarantee.

In response to receiving information responsive to a level of authorization, a transaction participant may determine whether the information is associated with the presented payment instrument. The transaction participant may make this determination before submitting the transaction for authorization and/or after the transaction has been authorized.

In some embodiments, a transaction participant may retain a “right of refusal” to reject a suspect transaction within a pre-determined timeframe. A right of refusal may be included in a liability schedule. For example, an issuer may initiate a chargeback when a merchant/acquirer does not submit the information responsive to the level of authorization within 24 hours of authorizing the transaction.

The level of authorization may be a first level of authorization. In response to a rejection of the first level of authorization, the code when executed by the processor, may determine a second level of authorization. The code may determine a third liability schedule for the second level of authorization. According to the third liability schedule, the merchant may bear more risk than according to the second liability schedule.

The code may transmit the second level of authorization and the third liability schedule to a transaction participant. In response to receiving information required by the second level of authorization, the code may authorize a transaction according to the third liability schedule. The code may submit the transaction to a transaction participant for authorization in accordance with terms of the third liability schedule.

The second liability schedule may impose a fee on the merchant for processing the debit transaction according terms in the liability schedule. The fee may be less than an interchange fee for submitting the transaction to a transaction processing network and processing the transaction according to the first liability schedule.

A liability schedule may impose a fee on the merchant for processing the transaction. The fee may vary based on a number of informational items provided by the merchant that are responsive to a requested level of authorization.

Apparatus may include, and methods may involve, a transaction authorization system. The system may include one or more non-transitory computer-readable media storing computer-executable instructions. The instructions, when executed by a processor on a computer system, may perform a method for dynamically insuring a transaction.

The method may include receiving a request from a customer to initiate the transaction as payment for a purchase from a merchant. The method may include generating a transaction record. The transaction record may be generated at a POS. The transaction record may identify an acquirer bank associated with the merchant and an issuer associated with the payment instrument. Such information included in the transaction record may typically not be included in a transaction record generated at a POS and/or transmitted to a transaction processing network.

When transaction is on-us, the method may include bypassing a transaction processing network associated with the payment instrument. The transaction processing network may be bypassed by submitting a transaction record from the acquirer directly to an issuer. The method may include calculating a fee for insuring a transaction participant against a post-authorization charge associated with the transaction. The method may include presenting the fee to the transaction participant and/or at the POS. Upon payment of the fee, a transaction participant may provide a liability schedule that includes a payment guarantee for the transaction.

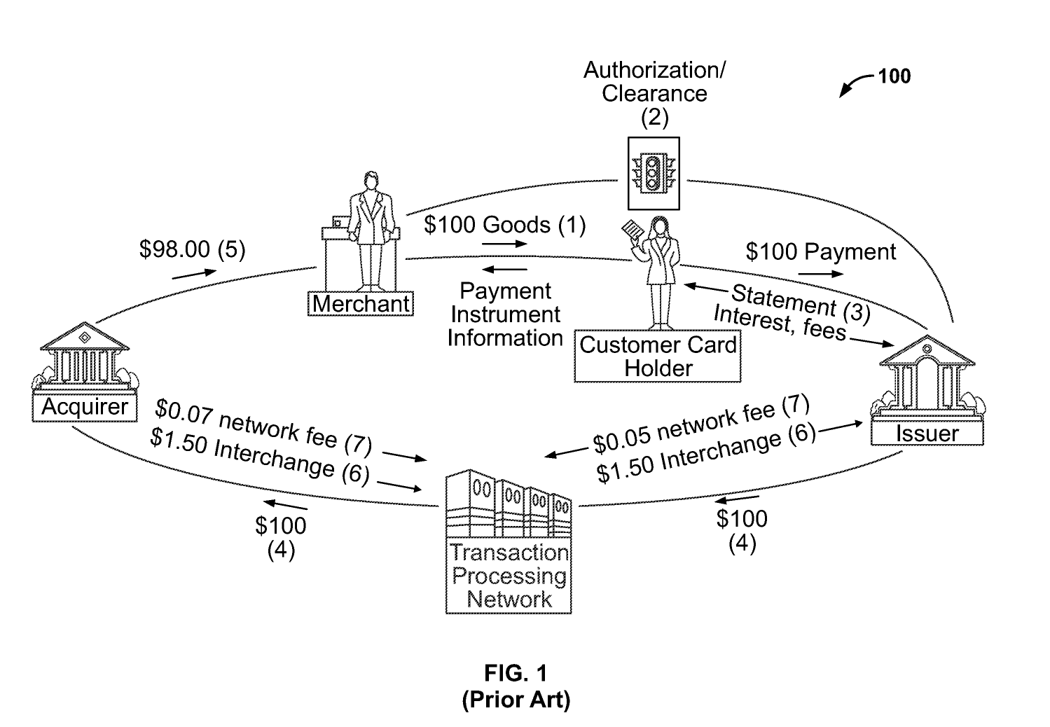

When issuer is not the acquirer and the transaction is off-us, the method may include transmitting a transaction record to the transaction processing network. The method may include receiving an authorization response from the transaction processing network. The method may include presenting the authorization response to the merchant and/or at the POS. When the transaction is off-us, a transaction record may be processed as shown above in FIG. 1.

In some embodiments, a transaction record may be a first transaction record. When the issuer is the acquirer and the transaction is on-us, a first transaction record may be submitted directly to the issuer. When the issuer is not the acquirer and the transaction is off-us, the method may include transmitting a second transaction record to the transaction processing network. The second transaction record may not include information included in the first transaction record. For example, the second transaction record may not include acquirer information or payment instrument information.

When the transaction is on-us, the method may include receiving, from the issuer, a plurality of verification requirements. Each of the verification requirements may be associated with a reduction in an amount of a fee charged for insuring a transaction participant against a post-authorization charge.

The method may include presenting the plurality of verification requirements to a transaction participant. The method may include presenting the plurality of reductions to a transaction participant. The method may include concurrently presenting the fee, reductions and the verification requirements to the transaction participant. The verification requirements, the reductions and the fee may be presented to a merchant.

The method may include receiving, from a transaction participant, information responsive to at least one of the plurality of verification requirements. In response to receiving the information, the method may include authorizing the transaction. Authorizing the transaction may include submitting a transaction record to a transaction information, the method may include reducing a fee for a insuring the transaction. The fee may be reduced by an amount corresponding to the reduction associated with the at least one of the plurality of verification requirements.

The plurality of verification requirements may include any informational items requested by a level of authorization. The plurality of verification requirements may include any of the informational items listed above in table 7. The plurality of verification requirements may include recording information displayed on the payment instrument and/or requesting that the customer enter a characteristic of the payment instrument. Illustrative payment instrument characteristics are shown above in table 2.

When a transaction is on-us, the method may include presenting the plurality of verification requirements to a transaction participant. The method may include receiving from the merchant information responsive the plurality of verification requirements and calculating a fee for insuring the transaction against a post-authorization charge based on the responsive information.

Apparatus may include, and methods may involve, an article of manufacture for authorizing a transaction initiated using a payment instrument. The article may include a computer usable medium having computer readable program code embodied therein and a processor for executing the code.

The code in said article of manufacture when executed by a processor may generate a transaction record that includes an identity of the payment instrument, an issuer associated with the payment instrument, a transaction processing network associated with the payment instrument, an acquirer bank of the merchant a value of the purchase and a location of the purchase.

When the transaction is on-us, the code may determine a risk of incurring a post-authorization fee for the transaction. The code may determine the risk based on the value of the purchase and the location of the purchase. When the risk exceeds a threshold risk level, the code may bypass a transaction processing network associated with the payment instrument. The transaction processing network may be bypasses by communicating the transaction record from a merchant/acquirer directly to the issuer.

The code may determine a service fee for insuring a transaction participant against a risk of incurring a post-authorization fee for the transaction. The code may determine verification information that may lower the risk below the threshold risk level.

The code may present a first option and a second option to a transaction participant. The first option may require paying a service fee to insure the transaction participant against a risk of incurring the post-authorization charge. The second option may require capturing verification information to insure the transaction participant against the risk of incurring the post-authorization charge.

When a risk of incurring a post-authorization charge does not exceed the threshold and/or the transaction is off-us, the code may transmit at least a portion of the transaction record to a transaction processing network. The code may receive an authorization response from the transaction processing network and present the authorization response to the transaction participant.

The code may vary a service fee for insuring the transaction based on a quantity of verification information received from a transaction participant. The verification information may include one more of the informational items shown above in table 7.

### Proof-of-Verification Network for Third Party Issuers

Apparatus may include, and methods may involve, a POS system. The POS system may dynamically select an authorization method for a transaction. The transaction may be initiated by a customer that presents a payment instrument to a merchant. The transaction may be a debit transaction. The system may include a non-transitory computer readable medium having computer readable program code embodied therein. The system may include a processor that executes the computer readable program code.

The system may present a payment guarantee option to a transaction participant. The system may present an option for the payment guarantee if the transaction is an on-us transaction or an off-us transaction. The transaction participant may be any suitable transaction participant such as those listed above in table 3. When the transaction participant selects the option, the system may transmit the transaction for authorization to a payment guarantee provider. The payment guarantee provider may be any suitable transaction participant such as those listed above in table 3.

The system may determine a level of authorization for the transaction. The system may transmit the level of authorization to a merchant. In response to receiving, from the merchant, information required by the level authorization, the method may include authorizing the transaction and/or associating the transaction with the payment guarantee.

When the merchant declines the payment guarantee, the system may submit the transaction to an issuer associated with the payment instrument for authorization. When the merchant declines the payment guarantee, the transaction may be submitted for authorization as shown above in FIG. 1.

A level of authorization may include code that when executed by the processor requires the customer to enter, at a point-of-sale, verification information to authorize the debit transaction. Illustrative verification information is shown above in table 7. The level of authorization may not allow the customer to sign at the point-of-sale to authorize the transaction.

Apparatus may include, and methods may involve, a transaction authorization system. The system may include one or more non-transitory computer-readable media storing computer-executable instructions. The instructions, when executed by a processor on a computer system, may perform a method of dynamically selecting an authorization network for a transaction.

The method may include receiving a request from a customer to initiate a transaction as a payment for a purchase of goods from a merchant. A transaction participant may be registered with a payment guarantee provider. A transaction participant may register for a payment guarantee for on-us and off-us transactions. A registry may be stored on one or more databases accessible by the system.

A transaction participant may conditionally register for a payment guarantee. For example, the transaction participant may register for a payment guarantee based on a value of a purchase, a location of a purchase or any suitable transaction attribute. Illustrative transaction attributes are shown above in table 4.

When the merchant is registered with a provider for a payment guarantee, the method may include bypassing an authorization process of an issuer associated with the payment instrument. The bypassing may include submitting the transaction for authorization to a payment guarantee provider for the transaction. The payment guarantee provider may operate a transaction processing network.

The method may include receiving, from the payment guarantee provider, a level of authorization for the transaction. The level of authorization may request that a merchant, acquirer, customer or any suitable transaction participant provide information items shown above in table 7. The method may include transmitting the level of authorization to a POS.

In response to receiving information required by the level authorization, the method may include associating the transaction with a payment guarantee. In response to receiving information required by the level authorization, the method may include authorizing the transaction.

The authorizing may include submitting the transaction for authorization to a transaction processing network associated with the payment instrument. The authorizing may include a payment guarantee provider obtaining an authorization from an issuer associated with the payment instrument. The authorizing may include the payment guarantee provider authorizing the transaction.

When the merchant is not registered for a payment guarantee for the transaction, the method may include submitting the transaction to an issuer associated with the payment instrument for authorization.

The method may include receiving from a payment guarantee provider a level of authorization and a fee for purchasing the payment guarantee. The method may include presenting the level of authorization and the fee to a merchant or other suitable transaction participant. The system may allow the transaction participant to obtain a payment guarantee for the transaction by selecting the level of verification, the fee or a combination of the level of verification and the fee. Providing informational items responsive to the level of verification may reduce the fee required to obtain the payment guarantee.

In response to a selection of the fee, the method may include presenting a level of authorization to the merchant and receiving from the merchant information responsive, at least in part, to the level of authorization. The method may include re-calculating the fee based on the information responsive, at least in part, to the level of authorization. The fee may be re-calculated when the information submitted is not associated with a payment instrument used to initiate the transaction. The fee may be re-calculated when the information is not fully responsive to the requested level of authorization.

A level of authorization may include a plurality of verification requirements and the information responsive, at least in part, to the level of authorization comprises less then all of the plurality of verification requirements.

In response to a selection of the fee, the method may include associating the transaction with the payment guarantee. After associating the transaction with the payment guarantee, the method may include submitting the transaction to the issuer associated with the payment instrument for authorization. In some embodiments, before associating the transaction with the payment guarantee, the method may include submitting the transaction to an issuer associated with the payment instrument for authorization.

In response to a selection of the level of authorization, the method may include submitting the transaction to a payment guarantee provider. The payment guarantee provider may formulate a level of authorization for the transaction. The level of verification may be formulated based on one or more transaction attributes. The level of verification may be formulated based on a risk that the transaction may incur a post-authorization charge.

In response to receiving information required by the level authorization, the system may transmit the information to an issuer of the payment instrument. The system may receive from the issuer confirmation that the information submitted in response to the level of authorization is valid and/or authorization for the transaction. The payment guarantee provider may issue a payment guarantee in response to receiving the confirmation and/or authorization.

Apparatus may include, and methods may involve, an article of manufacture for providing a merchant with liability protection for a purchase. The liability protection may immunize a transaction participant from a risk that the purchase may incur a post-authorization charge. The liability protection may be offered for on-us and off-us transactions. The purchase may be initiated by a customer presenting a payment instrument to a merchant at a POS.

Computer readable program code in said article of manufacture when executed by a processor may generate a transaction record. The transaction record may include any suitable transaction attribute information. Illustrative transaction attributes are shown above in table 4.

The code may transmit the transaction record to a liability protection provider. The code may determine a fee for providing the liability protection based on a value of the purchase and a location of the purchase. The code may determine a plurality of verification requirements based on a value of the purchase and a location of the purchase. Each of the verification requirements may be associated with a reduction in an amount of the fee.

The location may be determined based on a merchant category code associated with the point-of-sale. A merchant category code may classify a merchant based on a primary line of business.

For example, the merchant may be assigned the MCC based on whether the merchant provides predominately goods or provides predominately services. If a merchant provides both goods and services, the MCC assigned to the merchant may correspond to the greater portion of the merchant's business.

The MCC may classify the merchant based on a market segment serviced by the merchant. The MCC may be associated with a taxation status. Exemplary MCCs and associated market segment are shown in Table 8.

TABLE 8

| Illustrative Merchant Category Code | Illustrative Associated Market |
|---|---|
| (“MCC”) | Segment |
| 0742 | Veterinary Services |
| 4214 | Motor Freight Carriers and |
| | Trucking - Local and Long |
| | Distance, Moving and Storage |
| | Companies, and Local Delivery |
| | Services |
| 4812 | Telecommunication Equipment and |
| | Telephone Sales |
| 5047 | Medical, Dental, Ophthalmic, |
| | and Hospital Equipment and |
| | Supplies |
| 5172 | Petroleum and Petroleum |
| | Products |
| 5718 | Fireplace, Fireplace Screens, |
| | and Accessories Stores |

The MCC may be assigned by the acquirer. The acquirer may assign the MCC to the merchant at a time the merchant agrees to accept the payment instrument as a form of payment. The acquirer may assign the MCC to the merchant in response to the merchant agreeing to accept the payment instrument as a form of payment.

A transaction participant may be assigned multiple MCCs. For example, a merchant may provide pharmacy products and grocery products. The pharmacy products may be assigned a first MCC and the grocery products may be assigned a second MCC.

The MCC may be associated with a transaction attribute. For example, the merchant may provide predominately pharmacy products at a first location and predominately grocery products at a second location. A transaction that occurs at the first location may be associated with the first MCC. A transaction that occurs at the second location may be associated with the second MCC.

As a further example, the merchant may house a pharmacy and a grocery at a single address. The pharmacy may be associated with a first checkout location and the grocery may be associated with a second checkout location. Purchases made at the first location may be associated with the first MCC and purchases made at the second location may be associated with the second MCC.

The code may present a plurality of verification requirements and a liability protection fee to a transaction participant. In response to receiving information responsive to at least one of the plurality of verification requirements, the code may reduce the liability protection fee. The fee may be reduced based on a reduction associated with the at least one of the plurality of verification requirements received. In response to receiving information responsive to the at least one of the plurality of verification requirements, the code may associate the purchase with the liability protection.

A purchase may be one of a plurality of purchases. The payment instrument may be one of a plurality of payment instruments. The code when executed by the processor may receive the plurality of purchases. Each of the plurality of purchases may be associated with a payment instrument associated with a different issuer. The code may determine the liability protection fee for each of the plurality of transactions.

The code when executed by the processor, may receive a post-authorization charge. The post-authorization charge may be received from an issuer or any suitable transaction participant. The code may transmit a payment to the issuer for the post-authorization charge. The payment may at least partially reimburse the issuer for a cost associated with the post-authorization charge.

A post-authorization charge may include a first charge for investigating an allegation fraud for the transaction. The post-authorization charge may include a second charge associated with a chargeback of the purchase.

Illustrative embodiments of apparatus and methods in accordance with the principles of the invention will now be described with reference to the accompanying drawings, which form a part hereof. Some embodiments may omit steps shown or described in connection with the illustrative methods. Some embodiments may include steps that are not shown or described in connection with the illustrative methods. It will be understood that features shown in connection with one of the embodiments may be practiced in accordance with the principles of the invention along with features shown in connection with one or more other embodiments.

It is to be understood that other embodiments may be utilized and structural, functional and procedural modifications may be made without departing from the scope and spirit of the present invention.

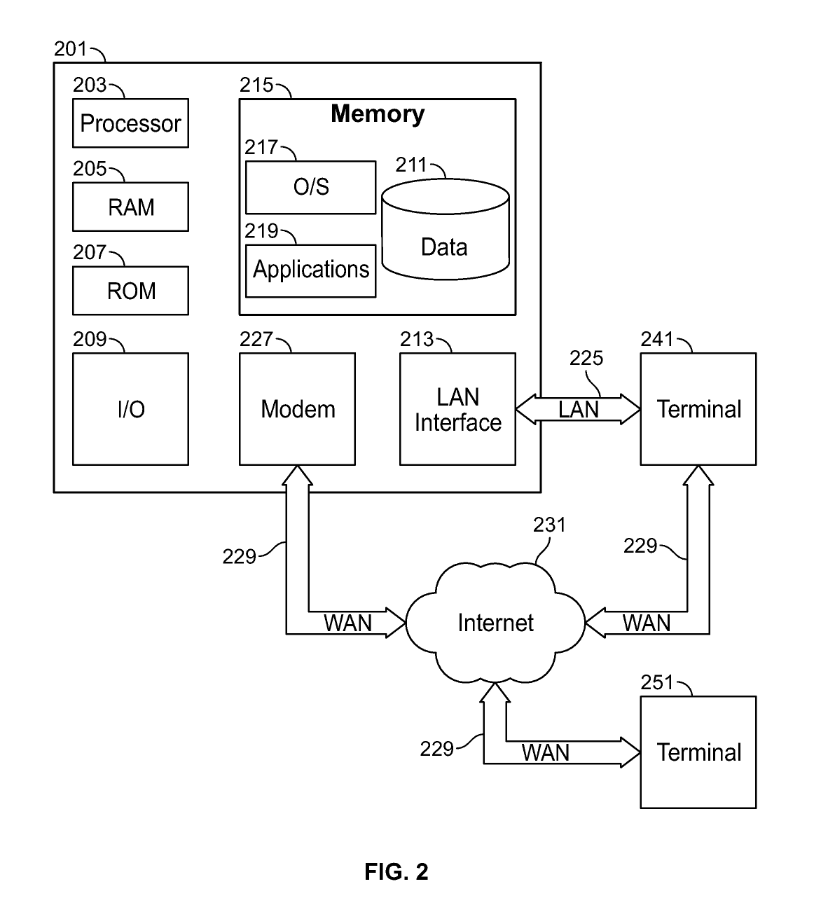

FIG. 2 is a block diagram that illustrates a computing device 201 (alternatively referred to herein as a “server or computer”) that may be used according to an illustrative embodiment of the invention. The computer server 201 may include processor 203 for controlling overall operation of the server and its associated components, including RAM 205, ROM 207, input/output (“I/O”) module 209, and memory 215.

I/O module 209 may include a microphone, keypad, touch screen and/or stylus through which a user of device 201 may provide input, and may also include one or more of a speaker for providing audio output and a video display device for providing textual, audiovisual and/or graphical output. Software may be stored within memory 215 and/or other storage (not shown) to provide instructions to processor 203 for enabling server 201 to perform various functions. For example, memory 215 may store software used by server 201, such as an operating system 217, application programs 219, and an associated database 211. Alternatively, some or all of computer executable instructions of server 201 may be embodied in hardware or firmware (not shown).

Server 201 may operate in a networked environment supporting connections to one or more remote computers, such as terminals 241 and 251. Terminals 241 and 251 may be personal computers or servers that include many or all of the elements described above relative to server 201. The network connections depicted in FIG. 2 include a local area network (LAN) 225 and a wide area network (WAN) 229, but may also include other networks. When used in a LAN networking environment, computer 201 is connected to LAN 225 through a network interface or adapter 213. When used in a WAN networking environment, server 201 may include a modem 227 or other means for establishing communications over WAN 229, such as Internet 231.

It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 219, which may be used by server 201, may include computer executable instructions for invoking user functionality related to communication, such as email, short message service (SMS), and voice input and speech recognition applications.

Computing device 201 and/or terminals 241 or 251 may also be mobile terminals including various other components, such as a battery, speaker, and antennas (not shown). Terminal 251 and/or terminal 241 may be portable devices such as a laptop, tablet, smartphone or any other suitable device for receiving, storing, transmitting and/or displaying relevant information.

Any information described above in connection with database 211, and any other suitable information, may be stored in memory 215. One or more of applications 219 may include one or more algorithms that may be used to evaluate transaction risk, determine whether a transaction is on-us or off-us, communicate transaction information, determine authorization methods, evaluate information responsive to a selected authorization method and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

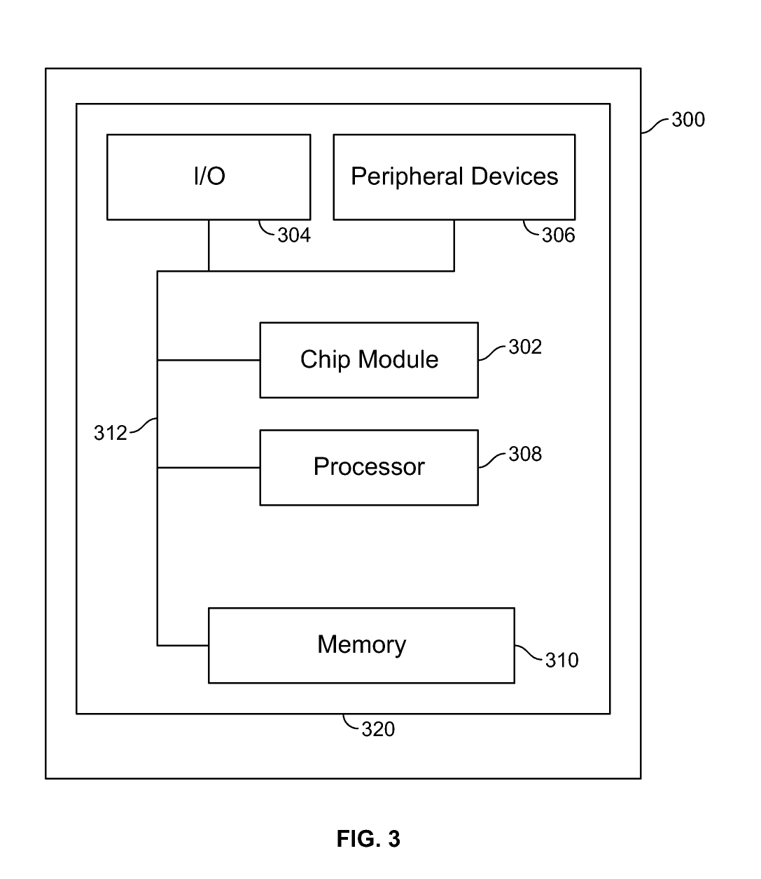

FIG. 3 shows illustrative apparatus 300. Apparatus 300 may be a computing machine. Apparatus 300 may include one or more features of the apparatus shown in FIG. 2. Apparatus 300 may include chip module 302, which may include one or more integrated circuits, and which may include logic configured to perform any other suitable logical operations.

Apparatus 300 may include one or more of the following components: I/O circuitry 304, which may include a transmitter device and a receiver device and may interface with fiber optic cable, coaxial cable, telephone lines, wireless devices, PHY layer hardware, a keypad/display control device or any other suitable encoded media or devices; peripheral devices 306, which may include counter timers, real-time timers, power-on reset generators or any other suitable peripheral devices; logical processing device 308, which may compute data structural information, structural parameters of the data, quantify indices; and machine-readable memory 310.

Machine-readable memory 310 may be configured to store in machine-readable data structures: authorization levels, liability schedules, fees and any other suitable information or data structures.

Components 302, 304, 306, 308 and 310 may be coupled together by a system bus or other interconnections 312 and may be present on one or more circuit boards such as 320. In some embodiments, the components may be integrated into a single chip. The chip may be silicon-based.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

The invention may be described in the general context of computer-executable instructions, such as program modules, being executed by a computer. Generally, program modules may include routines, programs, objects, components, data structures, etc., that perform particular tasks or store or process data structures, objects and other data types. The invention may also be practiced in distributed computing environments where tasks are performed by separate (local or remote) processing devices that are linked through a communications network.

In a distributed computing environment, program modules may be located in both local and remote computer storage media including memory storage devices. In a distributed computing environment, devices that perform the same or similar function may be viewed as being part of a “module” even if the devices are separate (whether local or remote) from each other.

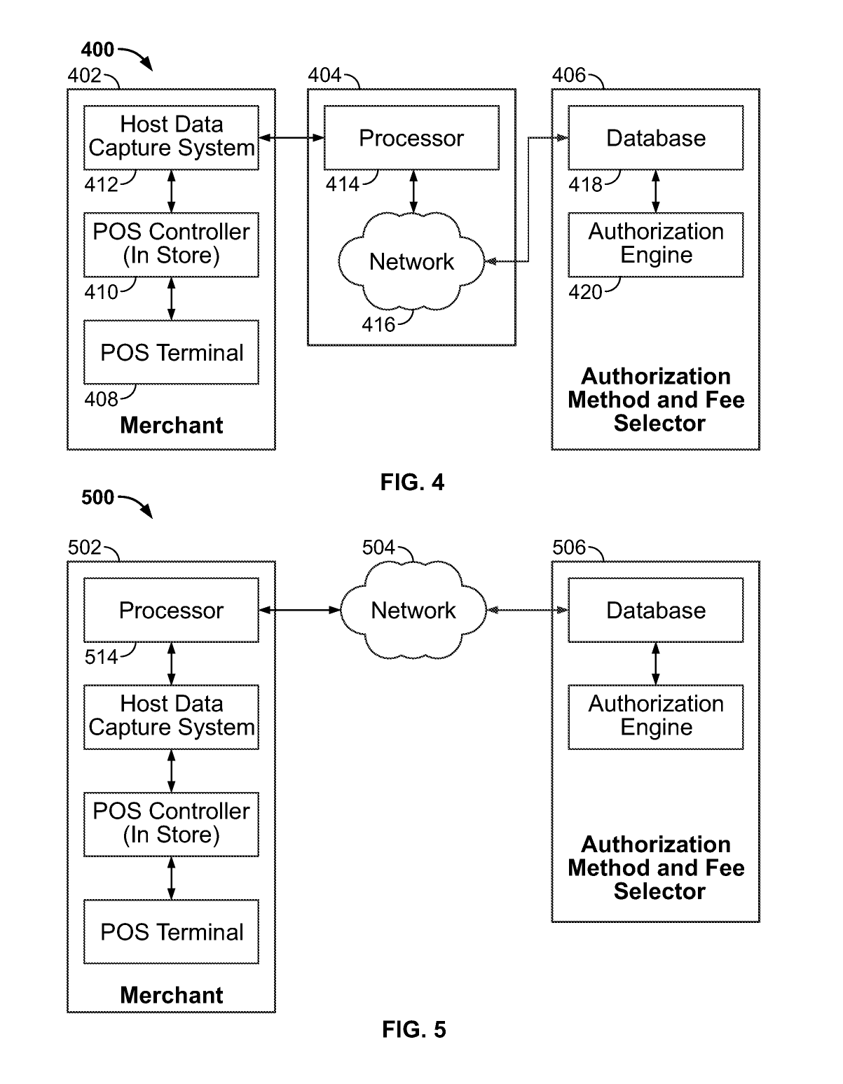

FIG. 4 shows illustrative system 400 for processing and communicating transaction information. Transaction information may include transaction records, authorization methods, authorization responses, information responsive to a selected authorization method, liability schedules or any suitable information.

System 400 may include merchant component 402, network component 404 and authorization method selection (“AMS”) component 406. In some embodiments, AMS component 406 may be operated by transaction participant such as an issuer. In general, a system such as 400 may include many merchant components such as 402, many AMS components such as 406 and many network components such as 404.

A customer may purchase goods by transferring payment instrument information from a personal data storage device, such as a credit card, debit card or smartphone, to point-of-sale (“POS”) terminal 408. POS terminal 408 may read the customer information from a payment instrument. The payment instrument may store data in a magnetic strip, a bar code, a silicon chip or any other suitable data storage device or format.

The payment instrument information may include issuer information, account information and any other suitable information. Illustrative payment instrument information is shown above in table 2.

POS terminal 408 may transmit transaction information to POS controller 410. The transaction information may include some or all of the payment instrument information and any other suitable information, such as the transaction amount, information regarding the purchased goods or other transaction attributes.

POS controller 410 may act as a server for providing user prompts and display layout information to one or more POS terminals such as POS terminal 408. POS controller 410 may receive transaction information from one or more of the POS terminals.

POS controller 410 may transmit the transaction information to host data capture system 412. Host data capture system 412 may store transaction information from POS controller 410. Host data capture system 412 may store accounting data, SKU data, location, time/date and other suitable data that may be included in a transaction record.

The transaction information may include merchant information. The merchant information may include information about the merchant, the merchant's business, the merchant's network membership, the merchant's business behavior and any other suitable information. The merchant information may be included in a transaction record.

Transaction information may include some or all of the information that is necessary to select a level of authorization for a transaction. The selected level of authorization may depend on interchange rates, network-fee rates, merchant type, merchant size, transaction processing method, and any other suitable transaction attributes.

The transaction information may be stored in any suitable element of merchant component 402, network component 404 and issuer component 406. For example, transaction information may be stored in processor 414. Processor 414 may include algorithms that may be used in conjunction with the transaction information to identify and quantify a risk that a transaction, corresponding to the customer transaction taking place at POS terminal 408, may incur a post-authorization charge. Processor 414 may include algorithms that may be used in conjunction with the transaction information to identify an authorization method for a transaction initiated at POS terminal 408.

Host data capture system 412 may create a transaction record based on the transaction information. The transaction record may include some or all of the transaction information. The transaction information may include one or more transaction attributes. Illustrative transaction attributes are shown above in table 4.

POS terminal 408 may have one or more interactive features that a customer may use. The features may provide the customer with instructions that may help the customer enter information responsive to a selected authorization method transmitted to merchant component 402. For example, POS terminal 408 may display a prompt requesting that the customer enter one or more of the verification information shown above in table 7.

Host data capture system 412 may route the transaction record to processor 414. Processor 414 may include a credit card network “processor,” which is known to those of ordinary skill in the art. The illustrative systems shown in FIGS. 4 and 5 may include one or more other processors that perform tasks that are appropriate for the components thereof.

Processor 414 may route the transaction record, via network 416, to database 418. The routing may be governed by the transaction information. For example, the routing may be governed by a bank issuer number (“BIN”) that is encoded in the customer's payment instrument. Authorization engine 420 may select an authorization method based on the transaction information. A level of authorization may include the selected authorization method. The authorization method may require that a customer provide additional information at a POS. The additional information may mitigate a risk of the transaction incurring a post-authorization charge.

Authorization engine 420 may transmit authorization information back to POS terminal 408 through network 416, processor 414, host data capture system 412 and POS controller 410. The authorization information may include the authorization method and/or decision. The transaction information may be used by processor 414 to route the authorization information back to the merchant and to the POS terminal where the customer is present.

FIG. 5 shows illustrative system 500 for processing and communicating transaction information. System 500 may include merchant component 502, network component 504 and AMS component 506. In general, a system such as 500 may include many merchant components such as 502 and many AMS components such as 506. System 500 may have one or more of the features that are described herein in connection with system 400 (shown in FIG. 4).

In system 500, processor 514 may be present in merchant component 502. Corresponding processor 514 is present in network component 404 (shown in FIG. 4).

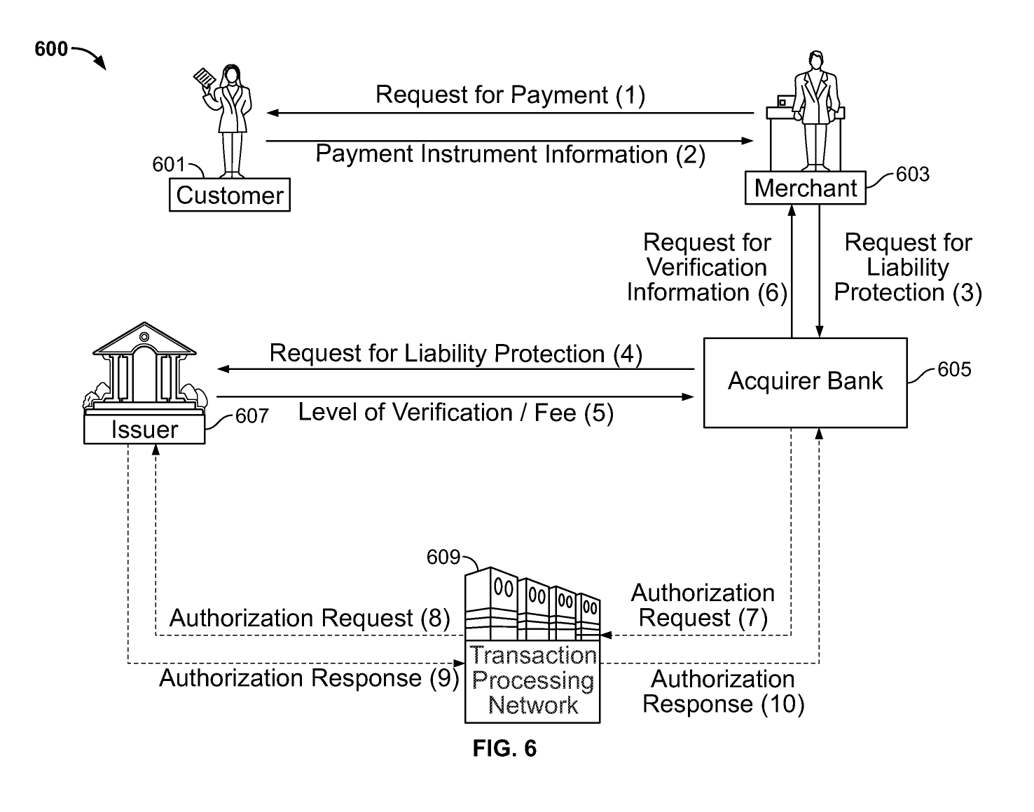

FIG. 6 shows illustrative information flow 600. At step 1, merchant 603 requests that customer 601 provide payment for a purchase. At step 2, customer 601 responds to the request by presenting a payment instrument to merchant 603. By presenting the payment instrument, customer 601 may transfer payment instrument information to merchant 603. Payment instrument information may be transferred to merchant 603 by swiping the payment instrument or any other suitable approach. At step 3, a POS system (illustrative POS systems are shown above in FIGS. 4 and 5) of merchant 603 submits a request for authorization to acquirer 605.

At step 4, acquirer 605 may submit a request for liability protection to issuer 607. The liability protection may include a payment guarantee for the purchase. Issuer 607 may be associated with the payment instrument presented by customer 601. Upon receiving the request for liability protection, issuer 607 may determine a level of verification for the purchase. Upon receiving the request for liability protection, issuer 607 may determine a liability protection fee for the purchase. The fee and/or level of authorization may be determined based on a one or more transaction attributes of the purchase.

At step 5, issuer 607 transmits the determined level of verification and the fee to acquirer 605. At step 6, acquirer 605 may requests that merchant 603 pay the liability fee to obtain liability protection (not shown). In some embodiments, acquirer 605 and merchant 603 may jointly pay the fee. At step 6, acquirer 605 requests that merchant s603 obtain information responsive to the level of verification.

In some embodiments, at step 4, acquirer 605 may request authorization for the purchase from issuer 607 concurrently with submitting a request for liability protection. In some embodiments, at step 7, acquirer 605 may submit an authorization request to transaction processing network 609. Step 7 may occur concurrently with step 4.

At step 8, when transaction processing network 609 receives an authorization request at step 7, transaction processing network 609 may transmit the authorization request to issuer 607. At step 9, issuer 607 may transmit an authorization response to transaction processing network 609. At step 10, transaction processing network 609 may transmit the authorization response to acquirer 605.

Acquirer 605 may retain an authorization response until merchant 603 transmits information responsive to the level of verification requested at step 4. In some embodiments, acquirer 605 may transmit the authorization response to merchant 603 before step 4 occurs such as when merchant 603 agrees to waive liability protection for the purchase.

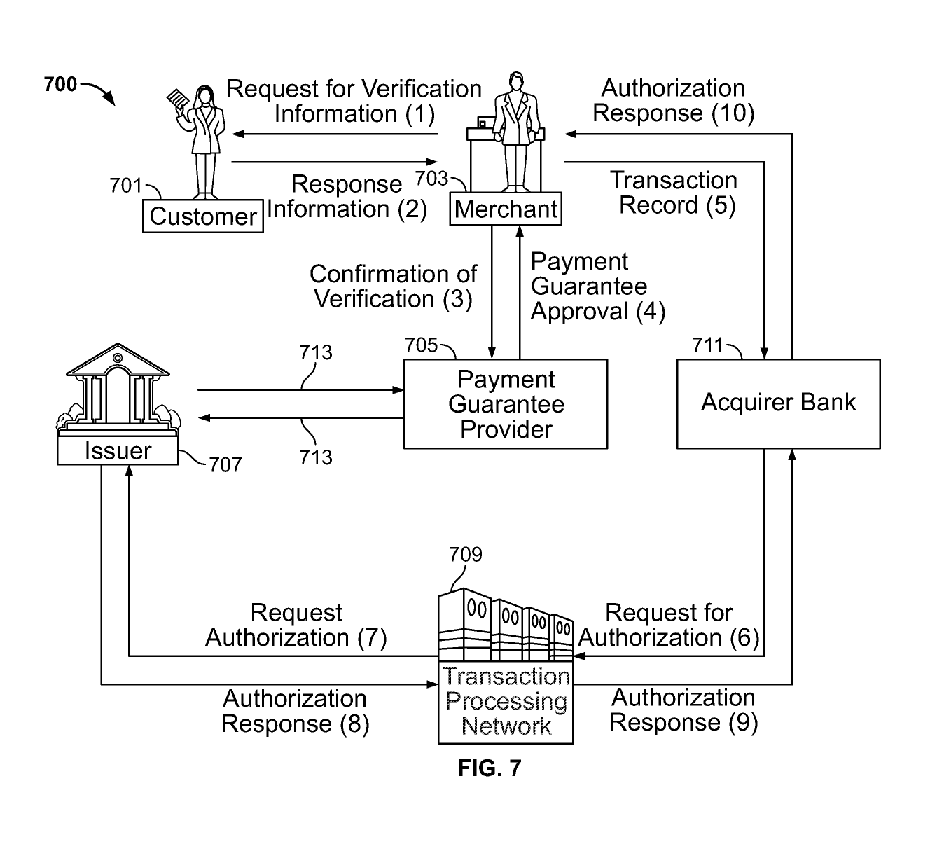

FIG. 7 shows illustrative information flow 700. At step 1, merchant 703 requests that customer 701 provide information responsive to a level of verification. The level of verification may be requested by issuer 707, payment guarantee provider (“PGP”) 705 or any suitable transaction participant. At step 2, customer 701 responds to the request by providing information responsive to the level of verification to merchant 703. In some embodiments, customer 701 may provider the responsive information using a POS system (illustrative POS systems are shown above in FIGS. 4 and 5).

At step 3, merchant 703 provides confirmation to PGP 705 that customer 701 has provided information responsive to the level of verification. At step 4, PGP 705 informs merchant 703 that a payment guarantee has been approved for a transaction initiated by customer 701.

In some embodiments, the payment guarantee approval may be a conditional approval. For example, PGP 705 may require that merchant 703 transmit the actual information (not just a confirmation) obtained from of customer 701. PGP 705 may require that merchant 701 transmit the actual information within a pre-determined timeframe such as within 24 hours from issuance of the conditional approval.

Upon receipt of the actual information obtained from customer 701, PGP 705 may request that issuer 707 verify that the information provided matches information in possession of issuer 707. PGP 705 may communicate with issuer 707 using communication lines 713.

At step 5, merchant 703 transmits a transaction record to acquirer 711. At steps 6-9, acquirer 711 may request and obtain an authorization response for the purchase. Acquirer 711 may request the authorization response before a payment guarantee is issued for a transaction.

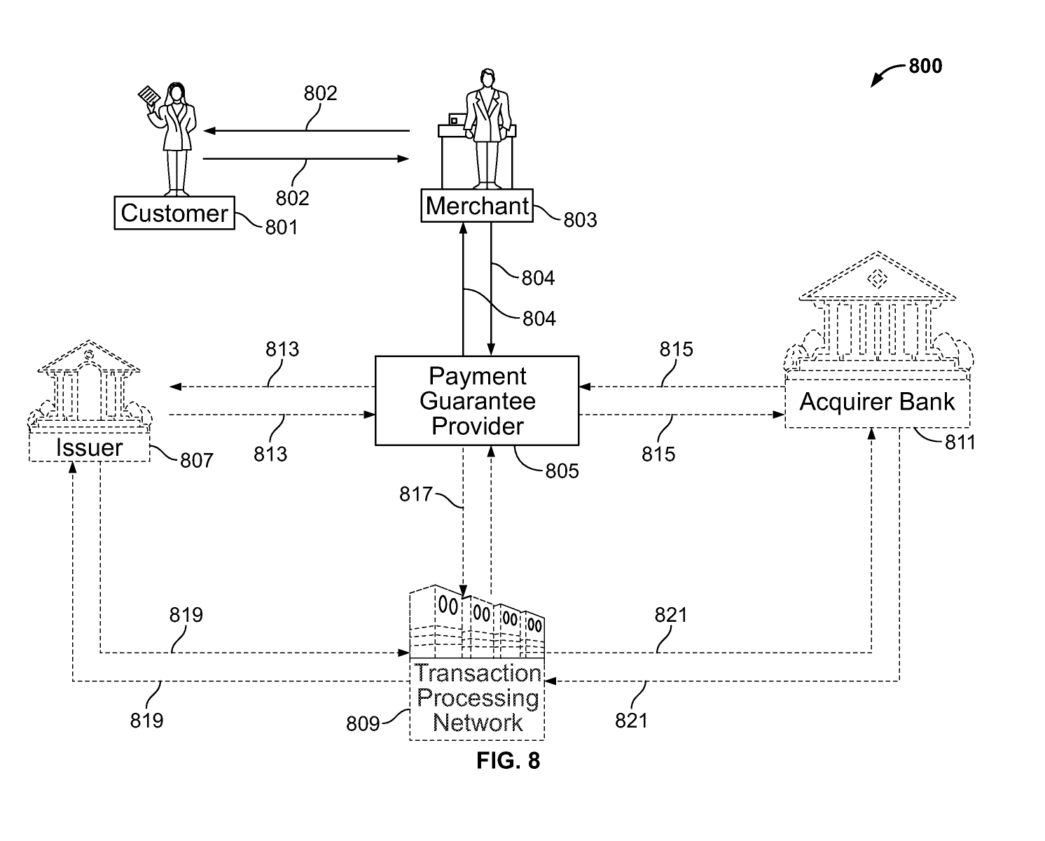

FIG. 8 shows illustrative arrangement 800. Arrangement 800 includes communication lines 802. Communication lines 802 represent a transfer of information between customer 801 and merchant 803. For example, merchant 803 may utilize communication lines 802 to request a payment from customer 801. Customer 801 may utilize communication lines 802 to provide payment instrument information to merchant 803.

Arrangement 800 includes communication lines 804. Communication lines 804 represent a transfer of information between merchant 803 and PGP 805. For example, merchant 803 may submit an authorization request to PGP 805. PGP 805 may provide a payment guarantee and/or authorization response to merchant 803.

Arrangement 800 may include communication lines 813. Communication lines 813 represent a transfer of information between PGP 805 and issuer 807. PGP 805 may communicate with issuer 807 after, or prior to, transmitting an authorization response and/or payment guarantee to merchant 803. In some embodiments, issuer 807 may include PGP 805.

Arrangement 800 may include communication lines 815. Communication lines 815 represent a transfer of information between PGP 805 and acquirer 811. In some embodiments, PGP 805 may receive transaction information from acquirer 811. Acquirer 811 may request liability protection for a transaction from PGP 805. PGP 805 may transmit an authorization response and/or payment guarantee to acquirer 811. In some embodiments, acquirer 811 may include PGP 805.

Arrangement 800 may include communication lines 817. Communication lines 817 represent a transfer of information between PGP 805 and transaction processing network 809. For example, PGP 805 may submit an authorization request to transaction processing network 809. Transaction processing network 809 may communicate with issuer 807 using communication lines 819. Transaction processing network 809 may communicate with acquirer 811 using communication lines 821. In some embodiments, transaction processing network 809 may include PGP 805

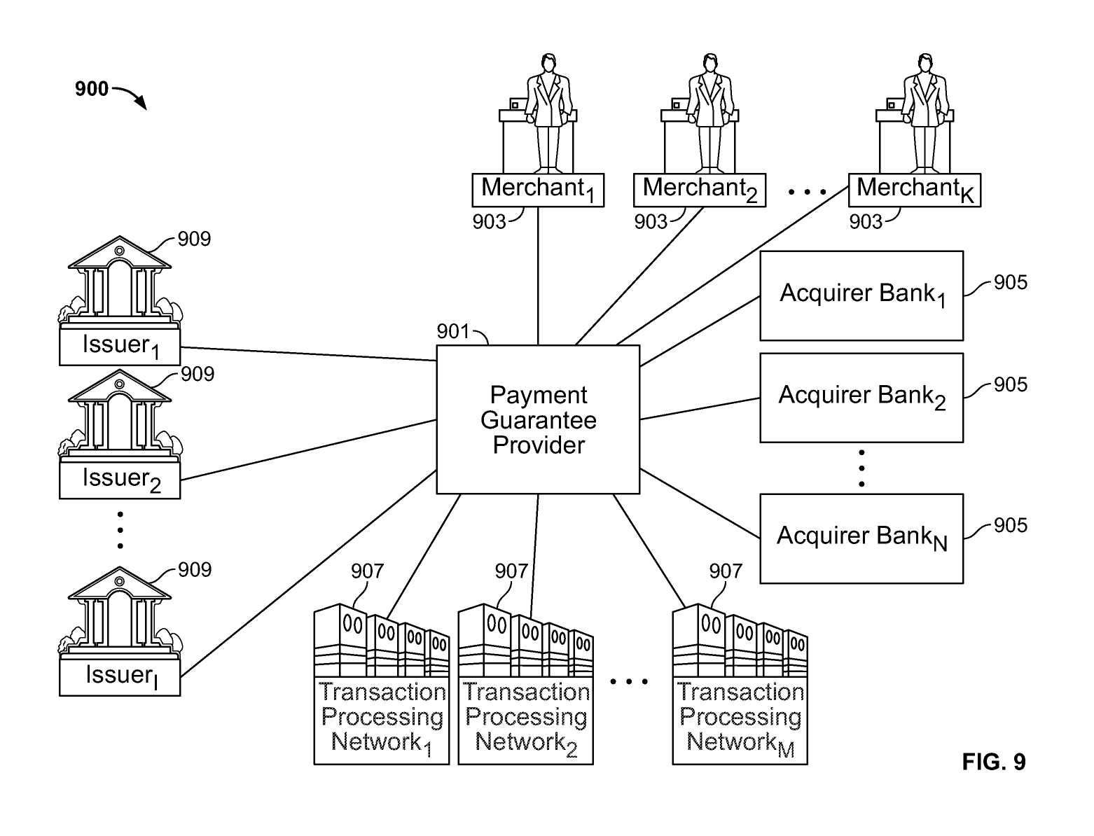

FIG. 9 shows illustrative arrangement 900. Arrangement 900 includes PGP 901. Merchants 903 may submit requests for a payment guarantee to PGP 901. The requests may include transaction records, payment instrument information or any suitable information. PGP 901 may be operated by one or more of merchants 903.

PGP 901 may communicate with a plurality of acquirers 905. Acquirers 905 may submit requests for a payment guarantee to PGP 901. The requests may include transaction records, payment instrument information or any suitable information. Acquirers 905 may receive confirmation from PGP 901 that a payment guarantee has been associated with a transaction. Acquirers 905 may receive other suitable communications from PGP 901 such as an authorization for the transaction. PGP 901 may be operated by one or more of acquirers 905.

PGP 901 may communicate with a plurality of transaction processing networks 907. Transaction processing networks 907 may submit requests for a payment guarantee to PGP 901. The requests may include transaction records, payment instrument information or any suitable information. Transaction processing networks 907 may configure their networks to transmit information requested by PGP 901. PGP 901 may submit authorization requests to transaction processing networks 907.

For example, a transaction processing network 907 may be configured to transmit a transaction record that includes a level or verification, information responsive to a level of verification, transaction attributes (shown above in table 4) or payment instrument information (shown above in table 2) or any suitable information. Such information may not be typically transmitted by a transaction processing network.

PGP 901 may submit authorization requests to transaction processing networks 907. PGP 901 may receive authorization responses from transaction processing networks 907. PGP 901 may be operated by one or more of transaction processing networks 907.

PGP 901 may communicate with a plurality of issuers 909. PGP 901 may submit transaction records to issuers 909. Based on the transaction records, before providing a payment guarantee for a transaction, issuers 909 may submit requests for a level of verification to PGP 901. The requests may require merchant 903 to obtain informational items shown above in table 7. PGP 901 may be operated by one or more of issuers 909.

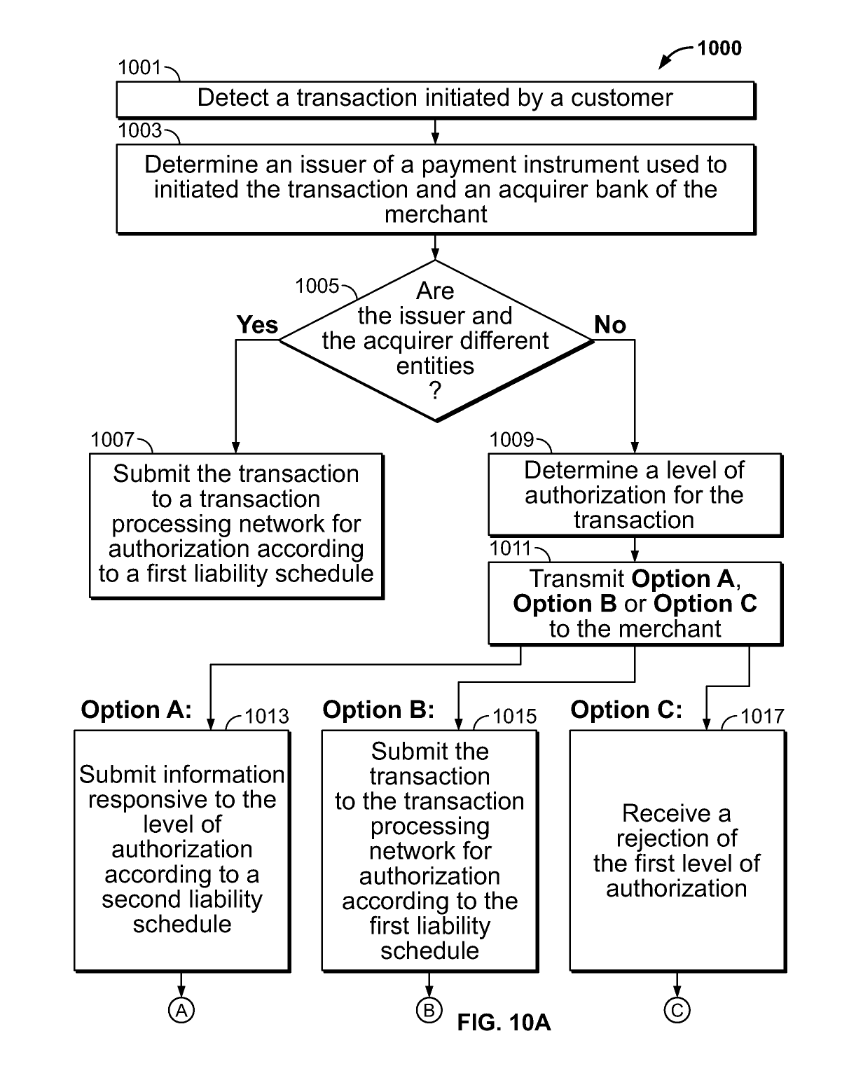

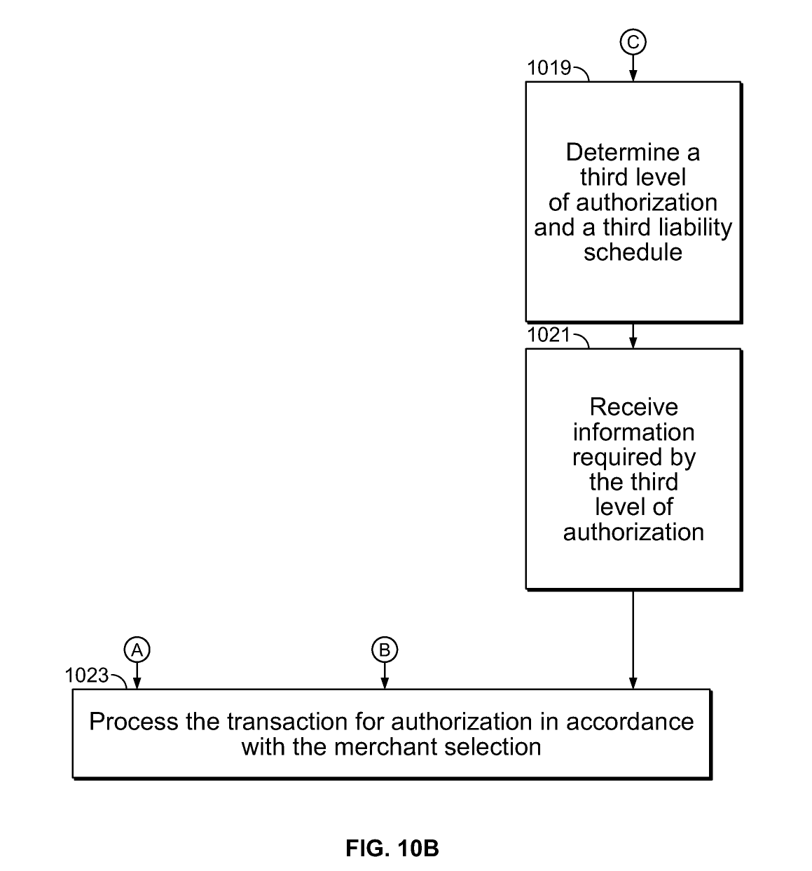

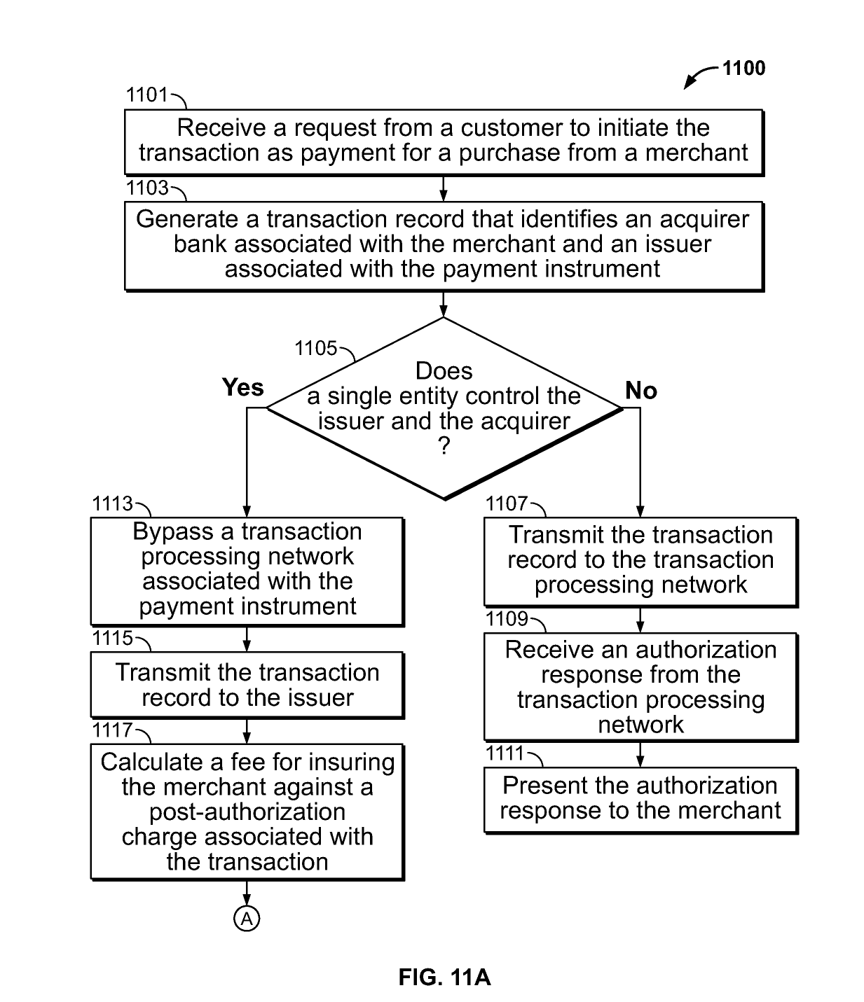

FIGS. 10A and 10B show illustrative process 1000. For the sake of illustration, one or more of the steps of the process illustrated in FIGS. 10A and 10B will be described as being performed by a “system.” The “system” may include one or more of the features of the apparatus, arrangements information or processes shown in FIGS. 1-9 and/or any other suitable device or approach. The “system” may be provided by an entity. The entity may be an individual, an organization, a transaction participant or any other suitable provider.

Process 1000 may begin at step 1001. At step 1001, the system detects a transaction initiated by a customer. At step 1003, the system identifies an issuer associated with a payment instrument used by the customer to initiate the transaction. At step 1003, the system also identifies an acquirer bank of the merchant.

At step 1005, the system determines if the issuer associated with the payment instrument and the acquirer of the merchant are operated by different entities (i.e., the transaction is off-us). At step 1007, if the issuer and the acquirer are operated by different entities, the system submits the transaction to a transaction processing network for authorization. The transaction processing network may process the transaction according to a first liability schedule imposed on the merchant by the issuer. The first liability schedule may not include a payment guarantee or other liability protection for the transaction.

If the issuer and the acquirer are operated by the same entity (the transaction is on-us), at step 1009, the system determines a level of authorization for the transaction. The level of authorization may be determined based on a risk that the transaction may incur a post-authorization charge or any suitable performance metric, such as those shown above in table 6.

At step 1011, the system transmits three options to the merchant: Option A, Option B and/or Option C. Step 1013 shows that Option A requests that the merchant submit information responsive to the level of authorization to obtain a second liability schedule. The second liability schedule may include a payment guarantee for the transaction or other suitable liability protection for the transaction.

Step 1015 shows that Option B requests that the merchant submit the transaction to the transaction processing network for authorization according to the first liability schedule (no, or minimal, liability protection for the transaction).

Step 1017 shows that Option C corresponds to a rejection of the first level of authorization. A merchant may feel that obtaining information responsive to the first level of authorization from a customer may be too onerous or damage goodwill of the merchant. A POS system, such as the systems shown in FIGS. 4 and 5 may be configured to determine whether to reject a level of authorization.

At step 1019, in response to the rejection of the first level of authorization, the system determines a third level of authorization. The third level of authorization may request less information than the second level of authorization (Option A). The third level of authorization may be associated with a third liability schedule. The third liability schedule may provide more liability protection (i.e., in amount of coverage) than the first liability schedule and less liability protection than the second liability schedule.

At step 1021, the system receives information required by the second level of authorization. At step 1023, the system processes the transaction for authorization in accordance with the merchant selection of Option A, Option B and Option C.

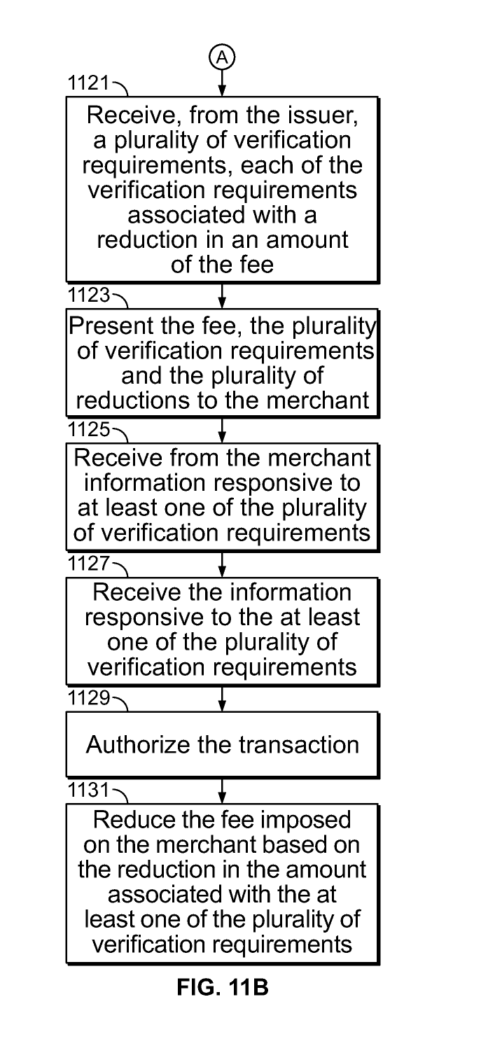

FIGS. 11A and 11B show illustrative process 1100. For the sake of illustration, one or more of the steps of the process illustrated in FIGS. 11A and 11B will be described as being performed by a “system.” The “system” may include one or more of the features of the apparatus, arrangements information or processes shown in FIGS. 1-10B and/or any other suitable device or approach. The “system” may be provided by an entity. The entity may be an individual, an organization, a transaction participant or any other suitable provider.

At step 1101, the system receives a request from a customer to initiate a transaction as payment for a purchase from a merchant. At step 1103, the system generates a transaction record that identifies an acquirer bank associated with the merchant and an issuer associated with the payment instrument. At step 1105, the system determines whether one entity controls the issuer and the acquirer.

At step 1107, if the issuer and the acquirer are not controlled by one entity, the system transmits the transaction record to a transaction processing network associated with the payment instrument. At step 1109, the system receives an authorization response from the transaction processing network. At step 1111, the system presents the authorization response to the merchant. In the authorization response includes an “APPROVE” response, the merchant may release goods to the customer. If the authorization response includes a “DENY” response, the merchant may request that the customer present a different payment instrument or another form of payment.

When the issuer and the acquirer are controlled by one entity, at step 1113, the system bypasses a transaction processing network associated with the payment instrument. At step 1115, the system may bypass the transaction processing network by transmitting a transaction record directly to an issuer associated with the payment instrument.

At step 1117, the system calculates a fee for insuring the merchant against a post-authorization charge associated with the transaction. The fee may be based on transaction attributes and/or performance metrics associated with the transaction.

At step 1121, the system receives, from the issuer, a plurality of verification requirements, each of the verification requirements associated with a reduction in an amount of the fee. In some embodiments, the system may determine the plurality of verification requirements and fee reductions. At step 1123, the system presents the fee, the plurality of verification requirements and the plurality of reductions to the merchant.

At step 1125, the system receives, from the merchant, information responsive to at least one of the plurality of verification requirements. At step 1127, the system, in response to receiving from the merchant information responsive to the at least one of the plurality of verification requirements, authorizes the transaction. The authorization provided to the merchant may include liability protection for the transaction. At step 1129, the system reduces the fee imposed on the merchant by an amount corresponding to the reduction associated with the at least one of the plurality of verification requirements.

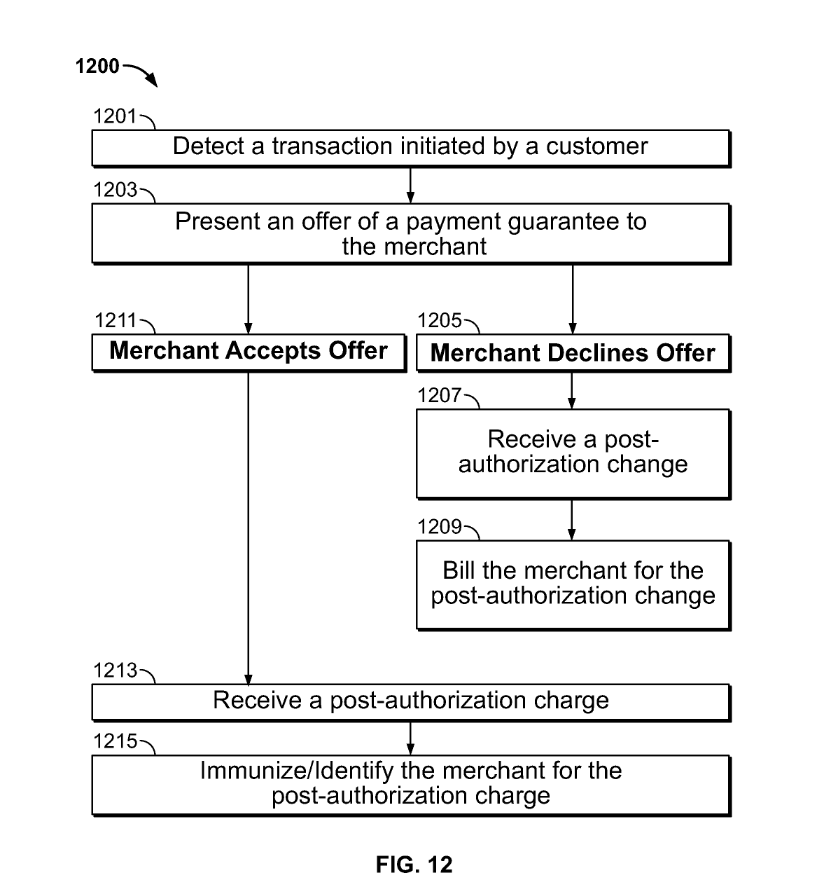

FIG. 12 shows illustrative process 1200. For the sake of illustration, one or more of the steps of the process illustrated in FIG. 12 will be described as being performed by a “system.” The “system” may include one or more of the features of the apparatus, arrangements information or processes shown in FIGS. 1-11B and/or any other suitable device or approach. The “system” may be provided by an entity. The entity may be an individual, an organization, a transaction participant or any other suitable provider.

At step 1201, the system detects a transaction initiated by a customer. At step 1203, the system presents an offer of a payment guarantee to the merchant. The payment guarantee may be offered the merchant regardless of whether the transaction is on-us or off-us. A default rule may process the transaction without a payment guarantee. At step 1205, the merchant declines the offer of the payment guarantee. When the merchant declines the offer, the transaction is processed without a payment guarantee.

At step 1207, the system receives a post-authorization charge associated with the transaction. The post-authorization charge may result from an allegation of fraud or a chargeback. At step 1209, the system bills the merchant for at least a portion of the post-authorization charge.

At step 1211, the merchant accepts the offer of a payment guarantee. At step 1213, the system receives a post-authorization charge associated with the transaction. At step 1215, as a result of the transaction being associated with the payment guarantee, the system immunizes or indemnifies the merchant for the post-authorization charge.

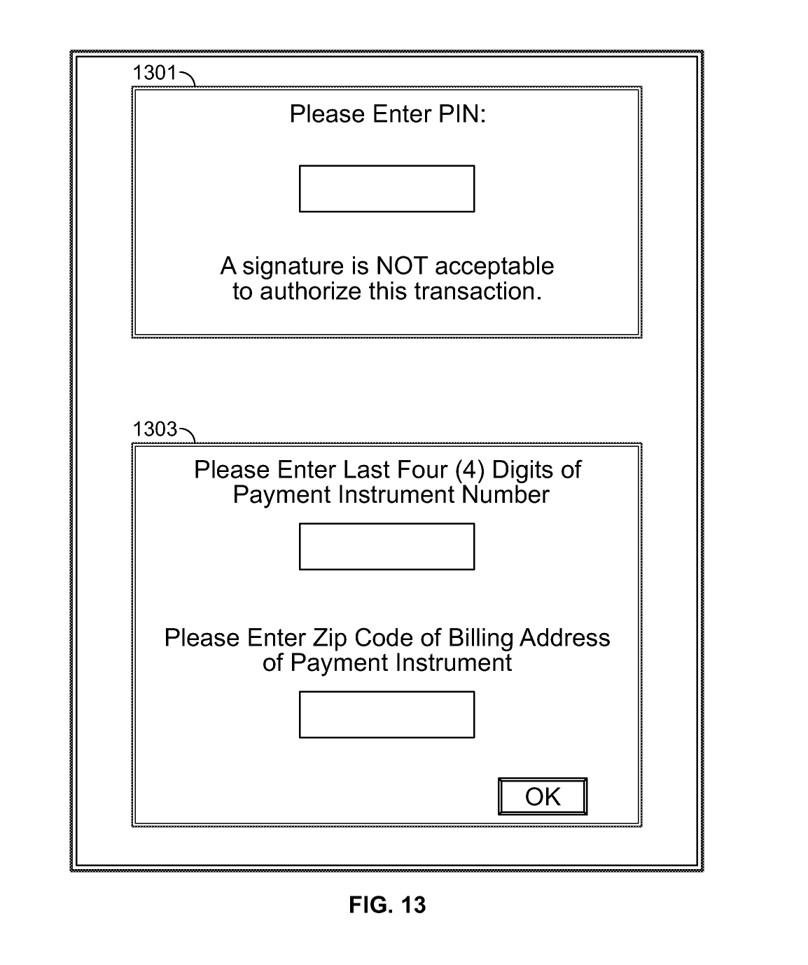

FIG. 13 shows illustrative screen shots 1301 and 1303. Screen shot 1301 shows an illustrative display on a POS terminal at a merchant location. Screen shot 1301 shows the POS terminal prompting a customer to enter information responsive to a level of authorization. Screen shot 1301 shows the POS terminal prompting the customer to enter a PIN. Screen shot 1301 shows that the customer is informed that a signature will not be accepted to authorize the transaction.

Screen shot 1303 shows an illustrative display on a POS terminal at a merchant location. Screen shot 1303 shows the POS terminal prompting a customer to enter information responsive to a level of authorization. Screen shot 1303 shows the POS terminal prompting the customer to enter the last four digits of a payment instrument number. In some cases of fraud, a payment instrument number encoded in a magnetic strip may not correspond to a number displayed on a face of the payment instrument. Comparing the digits entered by the customer to digits encoded in magnetic strip may expose a fraudulent payment instrument.

Screen shot 1303 shows that in addition to the last four digits of the payment instrument number, the customer is also requested to enter a zip code of a billing address associated with the payment instrument. Entering both the last four digits and the zip code may reduce a risk that the transaction may be associated with a post-authorization charge. In response to obtaining the information that reduces the risk, a payment guarantee may be associated with the transaction.

One of ordinary skill in the art will appreciate that the steps shown and described herein may be performed in other than the recited order and that one or more steps illustrated may be optional. The methods of the above-referenced embodiments may involve the use of any combination of methods, portions of methods, partially executed methods, elements, one or more steps, computer-executable instructions, or computer-readable data structures disclosed herein. In this regard, other embodiments are disclosed herein as well that can be partially or wholly implemented on a computer-readable medium, for example, by storing computer-executable instructions or modules or by utilizing computer-readable data structures.

Thus, systems and methods for a proof-of-verification network have been provided. Persons skilled in the art will appreciate that the present invention can be practiced by other than the described embodiments, which are presented for purposes of illustration rather than of limitation. The present invention is limited only by the claims that follow.

What is claimed is:

1. A point-of-sale system that is configured to dynamically select an authorization method for a debit transaction initiated by a customer that presents a payment instrument to a merchant, the system comprising:
a non-transitory computer readable medium having computer readable program code embodied therein; and
a processor configured to execute the computer readable program code;
the computer readable program code when executed by the processor:
determines an issuer of the payment instrument;
determines an acquirer bank of the merchant;
when the issuer and the acquirer bank are different entities, submits the debit transaction to a transaction processing network for authorization according to a first liability schedule imposed on the merchant by the issuer; and
when the issuer and the acquirer bank are the same entity:
determines a level of authorization for the debit transaction;
transmits to the merchant for selection:
a first option to submit information responsive to the level of authorization according to a second liability schedule imposed on the merchant by the issuer; and
a second option to submit the debit transaction to the transaction processing network for authorization according to the first liability schedule imposed on the merchant by the issuer; and
submits the debit transaction for authorization in accordance with the merchant selection;
wherein:
according to the second liability schedule the issuer agrees to bear a risk of incurring a fraud allegation fee or a chargeback fee associated with the debit transaction; and
according to the first liability schedule the merchant agrees to bear at least a portion of the risk.

2. The system of claim 1, the level of authorization comprising computer readable program code that when executed by the processor:
requires the customer to enter, at the point-of-sale, a personal-identification-number associated with the payment instrument; and
does not allow the customer to sign at the point-of-sale to authorize the debit transaction.

3. The system of claim 1, the level of authorization comprising computer readable program code that when executed by the processor:
requires the customer to enter, at the point-of-sale, a zip code associated with the payment instrument; and
requires the customer to sign to authorize the debit transaction.

4. The system of claim 1, the level of authorization comprising computer readable program code that when executed by the processor requires:
transmitting, from the point-of-sale, a characteristic displayed on the payment instrument; and
determining whether the characteristic is associated with the debit transaction.

5. The system of claim 1, the level of authorization comprising computer readable program code when executed by the processor requires:
capturing, at the point-of-sale, a barcode displayed on a photo identification of the customer; and
transmitting the barcode from the point-of-sale to the issuer.

6. The system of claim 1, the level of authorization comprising computer readable program code when executed by the processor requires transmitting, from the point-of-sale to the issuer, confirmation that a name displayed on a photo identification of the customer corresponds to a name displayed on the payment instrument.

7. The system of claim 1, wherein, when the level of authorization is a first level of authorization, the computer readable program code when executed by the processor, in response to a rejection of the first level of authorization:
determines a second level of authorization; and
transmits the second level of authorization and a third liability schedule to the point-of-sale.

8. The computer of claim 7, the computer readable program code when executed by the processor, in response to receiving information required by the second level of authorization, authorizes the debit transaction according to the third liability schedule;
wherein according to the third liability schedule the merchant bears more risk than according to the second liability schedule.

9. The system of claim 1, wherein the second liability schedule imposes a fee on the merchant for processing the debit transaction, the fee being less than an interchange fee included in the first liability schedule.

10. The system of claim 1 wherein the second liability schedule imposes a fee on the merchant for processing the transaction that varies with a number of informational items provided by the merchant responsive to the level of authorization.

11. A transaction authorization system comprising one or more non-transitory computer-readable media storing computer-executable instructions which, when executed by a processor on a computer system, perform a method for dynamically insuring a transaction, the method comprising:
receiving a request from a customer to initiate the transaction as payment for a purchase from a merchant;
generating a transaction record comprising an acquirer bank associated with the merchant and an issuer associated with the payment instrument;
when the issuer is the acquirer:
bypassing a transaction processing network associated with the payment instrument;
transmitting the transaction record to the issuer;
calculating a fee for insuring the merchant against a post-authorization charge associated with the transaction;
presenting the fee to the merchant at the point-of-sale;
when the issuer is not the acquirer:
transmitting the transaction record to the transaction processing network;
receiving an authorization response from the transaction processing network; and
presenting the authorization response to the merchant at the point-of-sale.

12. The authorization system of claim 11, the method further comprising, when the issuer is the acquirer:
receiving, from the issuer, a plurality of verification requirements, each of the verification requirements associated with a reduction in an amount of the fee;
presenting the plurality of verification requirements and the plurality of fees to the merchant;
receiving from the merchant information responsive to at least one of the plurality of verification requirements; and
in response to receiving from the merchant the information responsive to the at least one of the plurality of verification requirements:
authorizing the transaction; and
reducing the fee imposed on the merchant based on the reduction in the amount associated with the at least one of the plurality of verification requirements.

13. The authorization system of claim 12, wherein the plurality of verification requirements comprise:
comparing a photo identification of the customer to customer identification information displayed on the payment instrument;
recording information displayed on the payment instrument; and
requesting that the customer enter a characteristic of the payment instrument.

14. The authorization system of claim 11, wherein when the issuer is the acquirer, the method further comprises:
presenting to the merchant the plurality of verification requirements;
receiving from the merchant information responsive the plurality of verification requirements; and
calculating the fee based on the information.

15. The authorization system of claim 14 wherein the method further comprises concurrently presenting the fee and the verification requirements to the merchant.

16. The authorization system of claim 11, wherein in the method when the issuer is not the acquirer, the issuer does not bear a risk of incurring a post-authorization charge for the transaction.

17. An article of manufacture comprising a computer usable medium having computer readable program code embodied therein for authorizing a transaction initiated using a payment instrument, the computer readable program code in said article of manufacture when executed by a processor:
generates a transaction record comprising:
an identity of the payment instrument;
an issuer associated with the payment instrument;
a transaction processing network associated with the payment instrument;
an acquirer bank of the merchant;
a value of the purchase; and
a location of the purchase;
when the issuer is the acquirer:
determines, a risk of incurring a post-authorization charge for the transaction based on the value of the purchase and the location of the purchase;
when the risk exceeds a threshold risk level:
bypasses the transaction processing network associated with the payment instrument;
determines a service fee for insuring the merchant against a risk of incurring a post-authorization charge for the transaction; and
determines verification information that lowers the risk below the threshold risk level; and
presents to the merchant:
a first option to pay the service fee for insuring the merchant against the risk of incurring the post-authorization charge; and
a second option to capture the verification information for insuring the merchant against the risk of incurring the post-authorization charge; and
when the risk does not exceed the threshold and the issuer is not the acquirer:
transmits at least a portion of the transaction record to the transaction processing network;
receives an authorization response from the transaction processing network; and
presents the authorization response to the merchant.

18. The article of claim 17 the computer readable program code in said article of manufacture when executed by the processor varies the service fee based on a quantity of verification information received from the merchant.

19. The article of claim 17 wherein the verification information comprises:
a zip code associated with the payment instrument;
characters displaying on the payment instrument;
a personal-identification-number associated with the payment instrument; and
a barcode displayed on a photo identification of the customer.
